(19) United States
(12) Patent Application Publication
(10) Pub. No.: US 2005/0195721 A1
(43) Pub. Date: Sep. 8, 2005

(54) High density optical disc and method for creating and reproducing file system of the same

(76) Inventors: Kang Soo Seo, Anyang-si (KR); Jea Yong Yoo, Seoul (KR); Byung Jin Kim, Seongnam-si (KR); Sung Wan Park, Suwon-si (KR)

Correspondence Address: HARNESS, DICKEY & PIERCE, P.L.C., P.O. BOX 8910, RESTON, VA, 20195, US

(21) Appl. No.: 11/066,156

(22) Filed: Feb. 28, 2005

(30) Foreign Application Priority Data
Mar. 5, 2004 (KR) 10-2004-0015166

(51) Int. Cl. G11B 5/09; G11B 7/24

(52) U.S. Cl. 369/59.25; 369/275.3

(57) ABSTRACT

A high density optical disc and a method for creating and reproducing a file system of the same are disclosed. In recording a file system information on an optical disc, the method for creating a file system of a high density optical disc includes recording a main volume descriptor sequence and a reserve volume descriptor sequence, wherein each of the main volume descriptor sequence and the reserve volume descriptor sequence is recorded in a different ECC block. Accordingly, a highly reliable file system information may be provided. Furthermore, by using the newly created file system information, the optical disc may be reproduced with more efficiency

This application claims the benefit of the Korean Application No. 10-2004-0015166, filed on Mar. 5, 2004, which is hereby incorporated by reference as if fully set forth herein.

### BACKGROUND OF THE INVENTION

1. Field of the Invention

The present invention relates to a recording device, and more particularly, to a high density optical disc and a method for creating and reproducing a file system of the same.

2. Discussion of the Related Art

Optical discs are widely used as an optical recording medium for recording mass data. Presently, among a wide range of optical discs, a new high-density optical recording medium (hereinafter referred to as “HD-DVD”), such as a Blu-ray Disc (hereafter referred to as “BD”), is under development for writing and storing high definition video and audio data. Currently, global standard technical specifications of the Blu-ray Disc (BD), which is known to be the next generation technology, are under establishment as a next generation optical recording solution that is able to have a data significantly surpassing the conventional DVD, along with many other digital apparatuses.

Accordingly, optical reproducing apparatuses having the Blu-ray Disc (BD) standards applied thereto are also being developed. However, since the Blu-ray Disc (BD) standards are yet to be completed, there have been many difficulties in developing a complete optical reproducing apparatus. Particularly, in order to effectively reproduce the data from the Blu-ray Disc (BD), a file system for controlling files having data recorded therein is required, which should be provided as systematic and standardized information. However, in the Blu-ray Disc (BD) standard, a consolidated standard for creating and reproducing a file system is yet to be completed, thereby resulting in many limitations in extensively developing a Blu-ray Disc (BD)-based optical recording and/or reproducing apparatus.

### SUMMARY OF THE INVENTION

Accordingly, the present invention is directed to a high density optical disc and a method for creating and reproducing a file system of the same that substantially obviate one or more problems due to limitations and disadvantages of the related art.

An object of the present invention is to provide, in creating a file system within the optical disc according to the present invention, a method for providing a copy version so as to ensure reliability of the information, and most particularly, a method for determining a recording location of an original version and the copy version.

Another object of the present invention is to provide a method for effectively reproducing an optical disc (BD) by using the newly configured file system information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in recording a file system information on an optical disc, a method for creating a file system of a high density optical disc includes recording a main volume descriptor sequence and a reserve volume descriptor sequence, wherein each of the main volume descriptor sequence and the reserve volume descriptor sequence is recorded in a different ECC block.

In another aspect of the present invention, a high density optical disc includes a file system area within the optical disc, and an area for recording a main volume descriptor sequence for reproducing and controlling a file recorded on the file system area within the optical disc, and an area for recording a reserve volume descriptor sequence being a copy version of the main volume descriptor sequence, wherein each of the main volume descriptor sequence and the reserve volume descriptor sequence is recorded in at least one ECC block.

In a further aspect of the present invention, a method for reproducing a high density optical disc includes reading a main volume descriptor sequence information and a reserve volume descriptor sequence information, each being recorded in a different ECC block within a file system area of the optical disc, and reproducing a file recorded within the optical disc by using the read information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates a general view of a method for recording a file system of a high density optical disc according to the present invention;

FIGS. 2A and 2B illustrate a method for creating the file system of the high density optical disc according to an embodiment of the present invention; and

FIG. 3 illustrates an optical recording and/or reproducing apparatus according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

The “file system” used in the present invention refers to a set of information that controls a logical structure of an entire disc (hereinafter referred to as a “disc volume”) and also controls all of the files recorded within the optical disc, which is only identified and recognized by the system and not by the user. Also, the types of file systems that can be applied to the optical disc may be diverse in accordance with the attributes of the optical disc standard. And, the most commonly used file system type is a “universal disc format (UDF)”. Herein, the UDF file system will be given as an example for describing the present invention. Accordingly, in creating the file system, the present invention creates a copy version for a specific set of information. Most particularly, the methods for recording and creating a copy version information and an original information have different characteristics, which will now be described in detail.

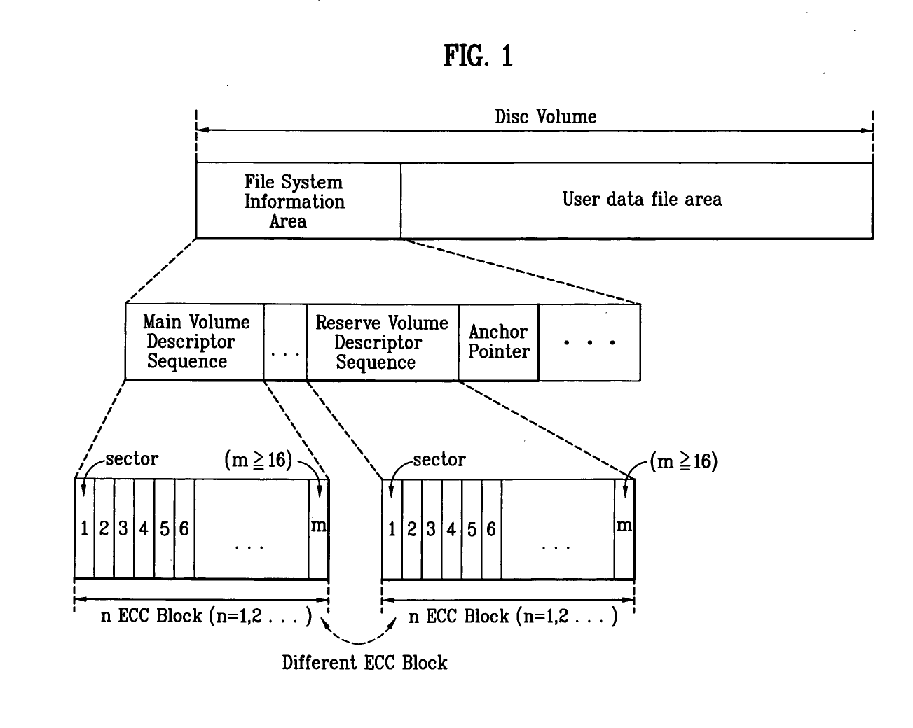

FIG. 1 illustrates a general view of a method for recording a file system of a high density optical disc according to the present invention. The optical disc is largely divided into a file system information area (also referred to as a “file system area”), and a user data file area. In addition, as described above, diverse information deciding the logical structure of the optical disc and information controlling the files are recorded in the file system area. More specifically, the information deciding the logical structure of the disc is called a “volume structure”, and the information controlling the files are referred to as a “file structure”. Accordingly, each information being recorded in the volume structure is referred to as a “descriptor”. And, in the UDF file system, descriptors may include a “Primary Volume Descriptor”, an “Implementation Use Volume Descriptor”, a “Partition Volume Descriptor”, a “Logical Volume Descriptor”, and an “Unallocatted Space Descriptor”, which are decided based upon a specific standard. And, a group of such descriptors is referred to as a “Volume Descriptor Sequence”.

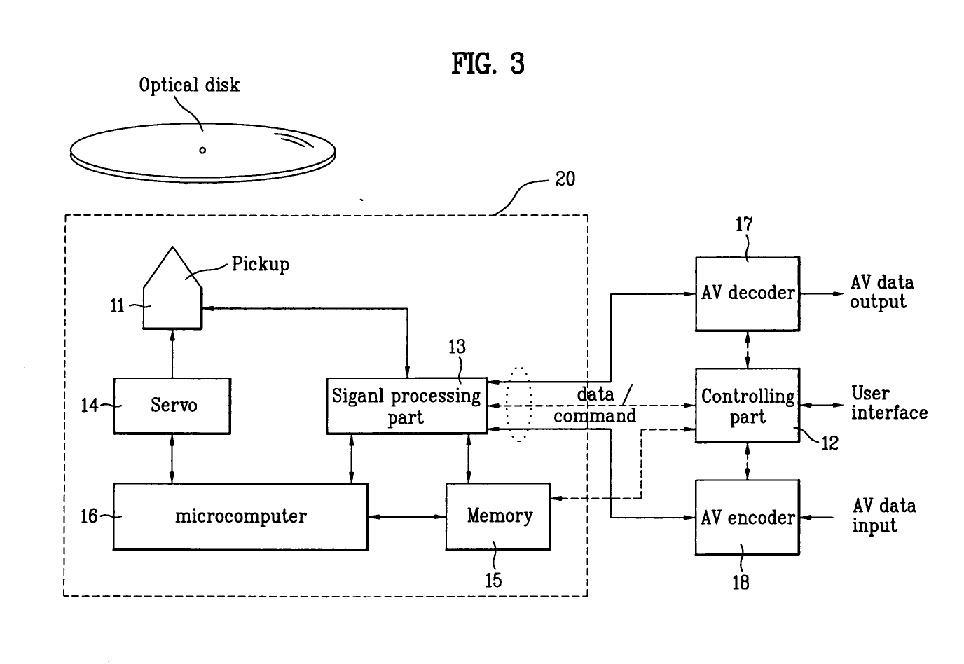

More specifically, in order to ensure robustness of the volume descriptor sequence, an original version and a copy version should both be included in the file system area. Herein, the original volume descriptor sequence is referred to as a “Main Volume Descriptor Sequence”, and the copy volume descriptor sequence is referred to as a “Reserve Volume Descriptor Sequence”. Moreover, diverse information controlling the files recorded on the optical disc are recorded within the file system area, as described above, and each of such information is referred to as a “File Structure”. And, generally, a File entry recording each of the files as a single entry is recorded in the file structure. Furthermore, an “Anchor pointer” is included on a predetermined specific location (e.g., LSN=256) within the file system area. When an optical disc is loaded, an optical recording and/or reproducing apparatus (shown in FIG. 3) reads the anchor pointer and, then, verifies a location at which the main volume descriptor sequence is recorded, thereby enabling verification of the logical structure of the entire optical disc by reproducing the corresponding area in a later process.

The present invention relates to a method for recording and creating a “Main Volume Descriptor Sequence” and a “Reserve Volume Descriptor Sequence” within the file system area, wherein each of the main volume descriptor sequence and the reserve volume descriptor sequence is recorded in a recording unit (hereinafter referred to as an “ECC block”) that is different from each other. If the main volume descriptor sequence and the reserve volume descriptor sequence are both recorded in the same ECC block, an error (or defect) may occur in the corresponding ECC block, thereby causing all of the information within the corresponding area to be lost simultaneously and instantly. Therefore, each of the main and reserve volume descriptor sequences is recorded in a different ECC block, so as to provide and ensure robustness of the volume descriptor sequences.

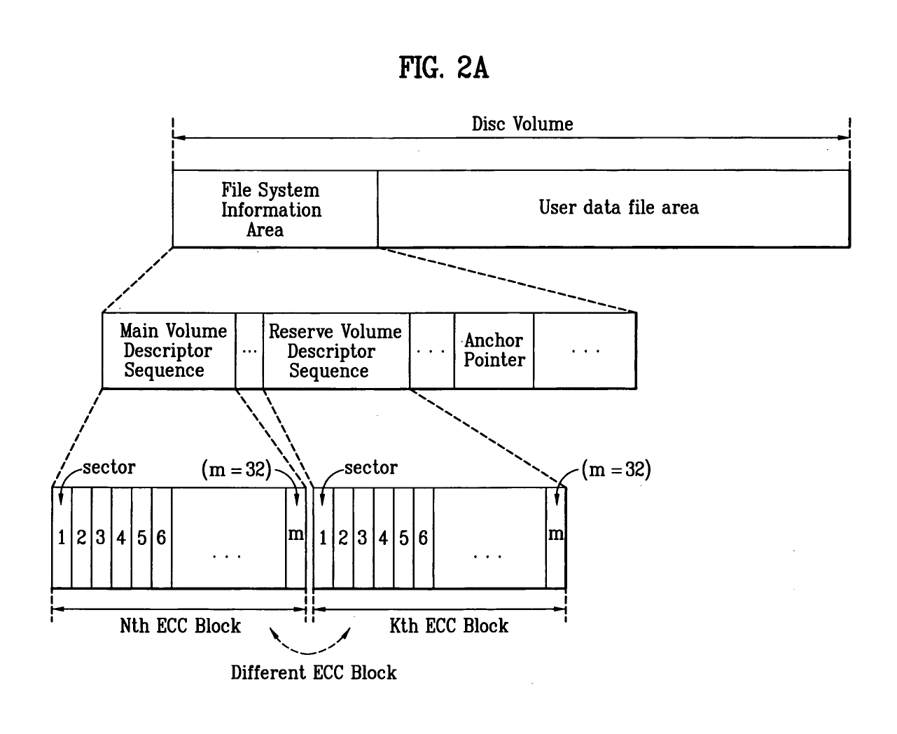

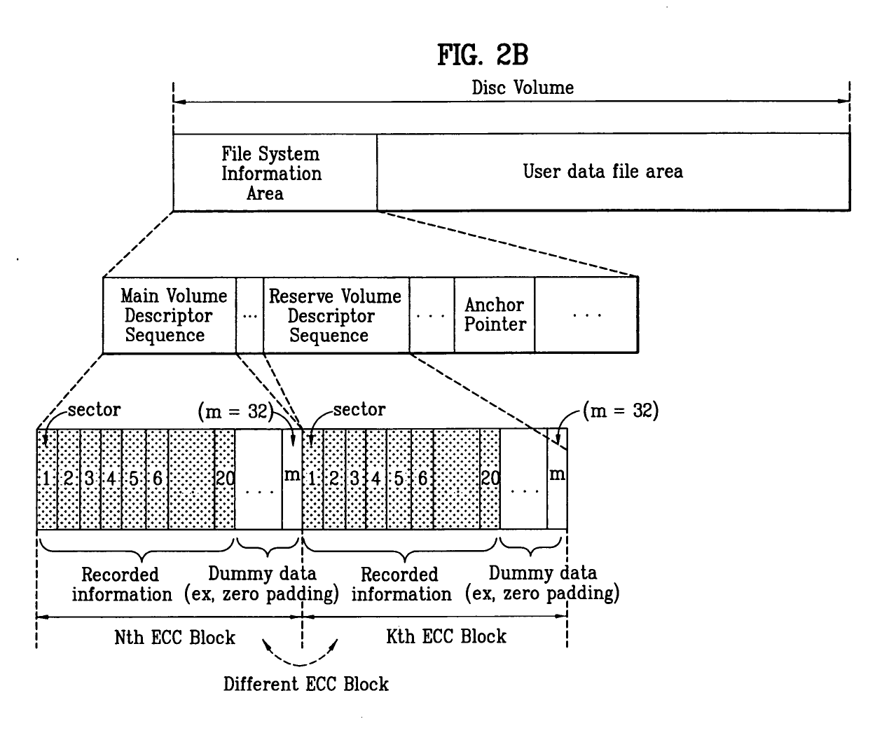

More specifically, the main volume descriptor sequence and the reserve volume descriptor sequence are recorded in the file system area, as shown in FIG. 1, yet each sequence is recorded in different n numbers of ECC blocks (wherein n=1, 2, . . . ). Accordingly, each of the main and reserve volume descriptor sequences is generally recorded in one ECC block. However, in the present invention, recording of each sequence is not limited to be processed in only one ECC block. Also, in a conventional DVD, an ECC block is formed of 16 sectors. However, the present invention is not limited to only 16 sectors, and an ECC block formed of more than 16 sectors has been shown to be more efficient and useful. For example, in a Blu-ray disc (BD), an ECC block is formed of 32 sectors, which will be described in detail with reference to FIGS. 2A and 2B.

FIG. 2A illustrates a method for creating the file system of the high density optical disc according to an embodiment of the present invention. More specifically, FIG. 2A illustrates an example of the Blu-ray disc (BD) having an ECC block formed of 32 sectors. Therefore, the same principle described in FIG. 2A may be applied to other types of optical discs having an ECC formed of at least 32 sectors. More specifically, the main volume descriptor sequence and the reserve volume descriptor sequence are recorded within the file system area, yet each sequence is recorded in a separate ECC block. For example, when the ECC block having the main volume descriptor sequence recorded therein is referred to as an n^{th} ECC block, and when the ECC block having the reserve volume descriptor sequence recorded therein is referred to as a k^{th} ECC block, the n^{th} ECC block and the k^{th} ECC block may be formed either to be adjacent to one another (i.e., k=n+1) or to be formed in physically separated areas (i.e., k=n+x, wherein x=2, 3, . . . ).

FIG. 2B illustrates a method for creating the file system of the high density optical disc according to an embodiment of the present invention. More specifically, FIG. 2B illustrates an example of a detailed method for recording the main volume descriptor sequence and the reserve volume descriptor sequence. Referring to FIG. 2B, the main volume descriptor sequence is recorded in one ECC block, wherein valid information is recorded in only 20 sectors of the 32 sectors formed in the ECC block. The information recorded area (i.e., the recorded 20 sectors) has been randomly decided by the applicant for simplicity of the description. Therefore, in this case, dummy data, such as “zero padding”, is recorded in the remaining surplus area (i.e., the non-recorded 12 sectors) within the one ECC block, so that other information cannot be recorded in the remaining area.

Further, the reserve volume descriptor sequence is an exact copy version of the information recorded within the main volume descriptor sequence, as described above. The copy version, which is the reserve volume descriptor sequence, is then recorded either in an ECC block (i.e., the k^{th} ECC block) that is adjacent to the ECC block (i.e., the n^{th} ECC block) having the main volume descriptor sequence recorded therein, or in another ECC block (i.e., the n^{th} ECC block) that is physically separated from the n^{th} ECC block. Therefore, when the “volume descriptor sequence” recording method, which is originally applied in an optical disc standard having an ECC block formed of 16 sectors, is directly applied to a new type of high density optical disc (e.g., a Blu-ray disc formed of “1 ECC block=32 sectors”), the problem of the “main volume descriptor sequence” and the “reserve volume descriptor sequence” being recorded in the same ECC block can be resolved.

FIG. 3 illustrates an optical recording and/or reproducing apparatus according to the present invention. The optical recording and/or reproducing apparatus 10 basically includes a pick-up unit 11 for reading data and file system information recorded within an optical disc, a servo 14 controlling the operations of the pick-up unit 11, a signal processor 13 either recovering the playback signal received from the pick-up unit 11 to a desired signal value, or modulating a signal to be recorded to an optical disc recordable signal and transmitting the modulated signal to the pick-up unit 11, a memory 15 temporarily storing the file system information read from the optical disc, and a microcomputer 16 controlling the above operations. The above-described member parts will be collectively referred to as a recording and/or reproducing unit 20.

The microcomputer 16 transmits the read file system information for recording and/or reproduction. Most particularly, when there is no error in the main volume descriptor sequence, the microcomputer 16 transmits the main volume descriptor sequence to a controller 12 for further application and usage. On the other hand, when an error occurs in the main volume descriptor sequence, the microcomputer 16 transmits the reserve volume descriptor sequence to the controller 12 for further application and usage. Herein, the controller 12 controls all operation of the optical recording and/or reproducing apparatus 10 according to the present invention. The controller 12 receives a user command through a user interface and, then, transmits the received command to the microcomputer 16 of the recording and/or reproducing unit 20, thereby controlling the microcomputer 16 to be operated as requested from the user command. Most particularly, the controller 12 either uses the file system information transmitted from the microcomputer 16, so as to ensure a disc volume that is required for recording, or transmits commands such as file structure modification to the recording and/or reproducing unit 20. An AV decoder 17 performs final decoding of output data depending upon the controls of the controller 12. And, in order to perform the function of recording a signal on the optical disc, an AV encoder 18 converts an input signal into a signal of a specific format (e.g., an MPEG-2 transport stream) depending upon the controls of the controller 12 and, then, provides the converted signal to the signal processor 13.

As described above, by using the high density optical disc and the method for creating and reproducing a file system of the same, a highly reliable file system information may be provided. Furthermore, by using the newly created file system information according to the present invention, the optical disc may be reproduced with more efficiency.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. In recording a file system information on an optical disc, a method for creating a file system of a high density optical disc, the method comprising:
recording a main volume descriptor sequence and a reserve volume descriptor sequence, wherein each of the main volume descriptor sequence and the reserve volume descriptor sequence is recorded in a different ECC block.

2. The method of claim 1, wherein the reserve volume descriptor sequence is a copy version of the main volume descriptor sequence.

3. The method of claim 1, wherein each of the main volume descriptor sequence and the reserve volume descriptor sequence is recorded in an ECC block.

4. The method of claim 1, wherein each of the main volume descriptor sequence and the reserve volume descriptor sequence is recorded in a plurality of ECC blocks.

5. The method of claim 1, wherein each of the main volume descriptor sequence and the reserve volume descriptor sequence is recorded in ECC blocks adjacent to each other.

6. The method of claim 1, wherein each of the main volume descriptor sequence and the reserve volume descriptor sequence is recorded in ECC blocks separated from each other.

7. The method of claim 1, wherein, when recording the main volume descriptor sequence, dummy data is recorded in a remaining area of the corresponding ECC block after a final recording of the main volume descriptor sequence.

8. A high density optical disc, comprising:
a file system area within the optical disc; and
an area for recording a main volume descriptor sequence for reproducing and controlling a file recorded on the file system area within the optical disc, and an area for recording a reserve volume descriptor sequence being a copy version of the main volume descriptor sequence,
wherein each of the main volume descriptor sequence and the reserve volume descriptor sequence is recorded in at least one ECC block.

9. The high density optical disc of claim 8, wherein the high density optical disc is a read-only blu-ray disc (BD-ROM).

10. The high density optical disc of claim 8, wherein the high density optical disc is a re-writable blu-ray disc (BD-RE).

11. The high density optical disc of claim 8, wherein the high density optical disc is a write-once blu-ray disc (BD-WO).

12. A method for reproducing a high density optical disc, the method comprising:
reading a main volume descriptor sequence information and a reserve volume descriptor sequence information, each being recorded in a different ECC block within a file system area of the optical disc; and
reproducing a file recorded within the optical disc by using the read information.
